(19) United States
(12) Patent Application Publication
(10) Pub. No.: US 2017/0220391 A1
(43) Pub. Date: Aug. 3, 2017

(54) METHOD OF DISTRIBUTING TASKS BETWEEN COMPUTER SYSTEMS, COMPUTER NETWORK INFRASTRUCTURE AND COMPUTER PROGRAM PRODUCT

(71) Applicant: Fujitsu Technology Solutions Intellectual Property GmbH, Munich (DE)

(72) Inventor: Heinz-Josef Claes, Ronneburg (DE)

(21) Appl. No.: 15/315,986

(22) PCT Filed: Jun. 1, 2015
(86) PCT No.: PCT/EP2015/062152

§ 371 Date: Dec. 2, 2016

(30) Foreign Application Priority Data
Jun. 3, 2014 (DE) 10 2014 107 788.1
Aug. 29, 2014 (DE) 10 2014 112 478.2

(51) Int. Cl. G06F 9/50; H04L 29/08; H04L 29/06

(52) U.S. Cl. CPC G06F 9/5027; H04L 63/0236; G06F 9/505; H04L 67/1008; H04L 67/288; H04L 63/0218

(57) ABSTRACT

A method of distributing tasks between computer systems in a computer network infrastructure includes parallel receiving a task file by a plurality of broker computer systems, negotiating a primary broker computer system from the broker computer systems, transmitting task information of the task file from the primary broker computer system to a primary processing computer system from a plurality of processing computer systems, and performing at least one action in the primary processing computer system by the transmitted task information, wherein all from the group of the processing computer systems keep predetermined network ports used for this method closed such that no connection establishment from the exterior is permitted and access via a network by the network ports is prevented, and a respective processing computer system is capable of establishing a connection to a respective broker computer system to fetch respective task information from the broker computer system.

### TECHNICAL FIELD

This disclosure relates to a method of distributing tasks between secured computer systems in a computer network infrastructure, a corresponding computer network infrastructure as well as a computer program product that performs a corresponding method.

### BACKGROUND

Distributed computer networks and so-called computer network infrastructures, respectively, describe a multitude of computer systems that can communicate with each other via data connections. Confidential content is exchanged to some extent and non-authorized persons shall not have any access possibility to it. In particular in computer network infrastructures that include server-client-topologies, confidential data, e.g., customer data or user data, is exchanged between client and server, wherein third party access to the data has to be suppressed.

Conventional security strategies to increase data protection include provisions (processes to be respected) or regulations (rules or prohibitions) for third parties, e.g., administrators, for example, whereby only restricted or controlled access to confidential data shall be permitted.

On the other hand, technical measures are provided to or in the computer systems to prevent physical and/or logical access to computer systems or restrict access only to authorized persons.

However, such approaches to improve data protection promote data security, but come with the disadvantage that they usually do not constitute obligatory measures to prevent access to confidential data.

Furthermore, for the data exchange or communication among one another, common computer network infrastructures work with access possibilities, for example, via network, or possibilities of addressability of services within the computer systems, which make them vulnerable to external attacks. This is because, for services to be addressable, a running program is required on one or multiple network ports of a computer system. This running program constitutes a potential security gap for external attacks via network.

As a result, there is a risk that under certain circumstances an attacker (hacker), who gains access to a computer system, may tap confidential data on this computer system and/or gains access to further computer systems in the computer network infrastructure through the attack, pretending to be trustworthy by a manipulated signature, for example.

On the other hand, essential communication structures are required in a computer network infrastructure to communicate and process information between individual computer systems. Such communication structures provide, inter alia, a distribution of tasks, i.e., a distribution of certain actions or tasks between a plurality of involved computer systems or determining a computer system from a group of computer systems to assume a task.

It could therefore be helpful to improve protection against attacks on computer systems within a computer network infrastructure, in particular unauthorized access to confidential data, by technical measures, but nevertheless provide a distribution of tasks within the computer network infrastructure that ensures a satisfactory forwarding of data within the computer network infrastructure.

### SUMMARY

I provide a method of distributing tasks between secured computer systems in a computer network infrastructure including parallel receiving a task file by a plurality of broker computer systems; negotiating a primary broker computer system from a group of broker computer systems for further processing of the task file; transmitting task information of the task file from the primary broker computer system to a primary processing computer system from a plurality of processing computer systems; and performing at least one action in the primary processing computer system by the transmitted task information, wherein all from the group of the processing computer systems keep predetermined network ports used for the method closed such that no connection establishment from the exterior is permitted and thus access via a network by the network ports is prevented, and a respective processing computer system is capable of establishing a connection to a respective broker computer system to fetch respective task information of the task file from the broker computer system.

I also provide a computer network infrastructure including a plurality of broker computer systems; and a plurality of processing computer systems, wherein the computer systems are configured to transmit data packets and/or instructions from at least one of the group of broker computer systems to at least one of the group of processing computer systems for processing the data packets and/or instructions, the group of broker computer systems and/or the group of processing computer systems are configured to negotiate and/or determine a primary broker computer system and/or a primary processing computer system for communication, all from the group of processing computer systems each comprise one access control unit configured to close predetermined network ports used for the method such that a connection establishment from the exterior to the processing computer systems is not permitted and thus access via a network by the network ports is prevented, and the processing computer systems are configured to establish a connection to a respective broker computer system to fetch corresponding data packets and/or instructions from the respective broker computer system.

I further provide a computer program product configured to be executed on one or a plurality of computer systems and which, when executed, performs the method of distributing tasks between secured computer systems in a computer network infrastructure including parallel receiving a task file by a plurality of broker computer systems; negotiating a primary broker computer system from a group of broker computer systems for further processing of the task file; transmitting task information of the task file from the primary broker computer system to a primary processing computer system from a plurality of processing computer systems; and performing at least one action in the primary processing computer system by the transmitted task information, wherein all from the group of the processing computer systems keep predetermined network ports used for the method closed such that no connection establishment from the exterior is permitted and thus access via a network by the network ports is prevented, and a respective processing computer system is capable of establishing a connection to a respective broker computer system to fetch respective task information of the task file from the broker computer system.

### BRIEF DESCRIPTION OF THE DRAWING

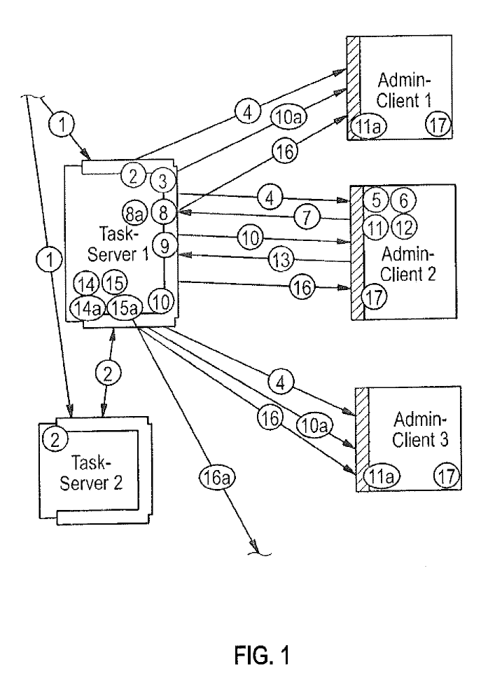

The Figure (FIG. 1) shows a schematic illustration of at least a part of a computer network infrastructure which is configured to perform load distribution between involved computer systems.

### LIST OF REFERENCE NUMERALS

Task server 1 broker computer system
Task server 2 broker computer system
admin client 1 processing computer system
admin client 2 processing computer system
admin client 3 processing computer system
1 to 17 method steps

### DETAILED DESCRIPTION

My method comprises the following steps:

parallel receiving of a task file by a plurality of broker computer systems,

negotiating a primary broker computer system from the group of broker computer systems for the further processing of the task file,

transmitting task information of the task file from the primary broker computer system to a primary processing computer system from a plurality of processing computer systems, and

performing at least one action in the primary processing computer system by the transmitted task information,

wherein all from the group of the processing computer systems keep predetermined network ports used for the method closed such that no connection establishment from the exterior is permitted and thus access via a network by the network ports is prevented, and

a respective processing computer system is capable of establishing a connection to a respective broker computer system to fetch respective task information (or other data) from the task file of the broker computer system.

Such a method allows a load distribution such that a primary computer system is selected from a group of broker computer systems for the further processing of an incoming task file. This way, multiple individual tasks can be distributed over multiple broker computer systems so that the overall load of the group of the broker computer systems is not focused on one individual computer system, but can be divided within the group of broker computer systems.

Furthermore, the method provides the advantage that a dedicated broker computer system is defined as a primary computer system that can control the further course of the method in an automated manner. This particularly includes communication with a plurality of processing computer systems within the computer network infrastructure.

In the method explained herein, all systems from the group of processing computer systems are to be understood as encapsulated systems. Access via a network to the computer systems is not possible or significantly complicated at least under certain operating conditions (advantageously permanently while performing the method explained herein or the above method steps).

The term “predetermined network ports” means that in all processing computer systems all or only selected security-relevant network ports, e.g., network ports used for the method, are permanently or temporarily closed.

This provides the advantage that no programs are configured or required on the processing computer systems that externally listen to the respective network ports for addressability or connection establishment purposes or constitute a respective safety gap (e.g., by buffer overflow). Thus, in this context, the term “closed network ports” means for the ports that they are no “listening ports,” i.e., no connection establishment from the exterior is permitted. In this case, a third party is not able to externally authenticate or log-in on a respective processing computer system via network, e.g., via a secure-shell-(SSH-) Daemon in Unix-based computer systems or to perform special actions on the processing computer system.

However, local access to a respective processing computer system may be configured for a first user group, (e.g., for users of the respective processing computer system). For other third parties, however, local access to a respective processing computer system is prevented.

In contrast to the processing computer systems, however, the method allows external access to a broker computer system from the group of broker computer systems. Each of the group of broker computer systems is accessible via network as an “open system” having at least one listening, open network port. This means that programs run on a broker computer system and/or applications are prepared so that a processing computer system may access a broker computer system and establish a connection to the broker computer system to fetch respective task information of the task file according to the method presented herein (via a then-established connection) from a broker computer system to perform at least one action by the task information, or store replies and/or results of the locally-performed action in the broker computer system. In terms of security, such an “open” broker computer system is to be assessed just like a traditional, specially-secured computer system.

Thus, each of the broker computer systems, in this case the primary broker computer system, serves as a (secured, but listening) broker for communication with the group of processing computer systems, which, however, are encapsulated per se. This way, a predetermined method of distributing load between broker computer systems to forward information in a targeted manner by the group of broker computer systems is possible despite encapsulated processing computer systems.

In this context, task files for executing predetermined processes (tasks) are prepared in a processing computer system and/or a (not further specified) target computer system, which is to perform a predetermined task by the task file.

Such processes may be, for example:

storing and/or processing (e.g., supplementing) transferred data,

restarting a program,

the instruction for physical access to the respective computer system,

recovering backup data, or

SSH access to the respective computer system.

Certainly, respective combinations of such actions and instruction are possible. The particularity of my method lies with the fact that an event control of a processing computer system or of a target computer system not further specified herein is enabled by the task file for the corresponding forwarding of information.

A task file is basically different from a pure command to a respective processing computer system because the command requires a program externally-open and therefore vulnerable to attacks on the side of the processing computer system for the evaluation of this system. However, as already explained, such a program is omitted in my method due to a lack of access via a network to a respective processing computer system.

However, instructions to a processing computer system can be prepared on a broker computer system and fetched by the processing computer system that automatically establishes a connection to the broker computer system. The instructions can be processed locally then, on the processing computer system, for example.

“Task information of the task file” is information present (for example, embedded) in the task file. This can be information concerning instructions, descriptions, processing data, signatures, passwords or the like regarding actions and tasks, respectively, to be executed. The task information may include parts from the task file or also the entire task file. This means that parts of the task file or as well the entire task file can be transmitted to a processing computer system as task information.

To transmit task information from primary broker computer systems to the primary processing computer systems, a process can be initiated, the process requesting the selected task information in the primary broker computer system and transmitting it from the primary broker computer system to the primary processing computer system in an automated manner. Automated transmitting of task information from the primary broker computer system to the primary processing computer system is advantageously designed such that a third party does not have any options to externally affect the computer system, and thus a risk for manipulations of the primary processing computer system via task information is excluded. Task information may be encrypted, for example. A (different) encryption can also be applied multiple times to parts of the task information or entire data packets (containing task information). In the primary processing computer system, validity of the task information can be verified and a respective action can be performed. Validity of the task information can be verified by signatures with which data packets have been signed.

After successful processing of the task information in the primary processing computer system, the task information can be transmitted back to the primary broker computer system. The task information can then be transported further in the process to a target computer system for performing a task in the target computer system by the processed task information, for example.

Advantageously, the method according to the type explained herein additionally comprises the following steps:

generating a first interaction packet in which the task information is included by the primary broker computer system,

transmitting the first interaction packet from the broker computer system to the primary processing computer system,

extracting the task information from the first interaction packet for performing the at least one action in the primary processing computer system,

generating a second interaction packet, in which a replay to the first interaction packet is included, by the primary processing computer system, and

transmitting the second interaction packet from the primary processing computer system back to the primary broker computer system after performing the at least one action.

Packing the task information in an interaction packet allows sending further information, which can be signatures of the primary broker computer system, authorizations, commands or the like, for example. Advantageously, the task information of the original task file or the task information after performing the action in the primary processing computer system remains unchanged. This way, information for communication between the primary broker computer system and the primary processing computer system can be differentiated from task information of the task file for performing a task on a further target computer system, for example. The interaction packet can be some type of “sub task file,” for example, in which certain interaction parameters between the primary broker computer system and the primary processing computer system are set. These parameters may then be transmitted back to the primary broker computer system as return value or be supplemented with return values in the second interaction packet and embedded into the original task file.

Furthermore, it is possible to secure the original task file or the task information thereof, respectively, against manipulation within the primary broker computer system by a signature of an independent (not further specified) key computer system as additional security entity. Such a “basic signature” remains verifiable despite packing the task information into the interaction data packet, and ensures the authenticity of the task information. Triggering a (criminal) action in a processing computer system by a manipulated broker computer system can therefore be prevented or at least significantly complicated, because the “basic signature” offers a certain security against falsification.

In the method of the explained type, the at least one action in the primary processing computer system preferably comprises at least:

supplementing the task information by further data, and/or

signing the task information with at least one private key, and/or

encrypting the task information with a public key of a target computer system.

To perform the action in the primary processing computer system, the task information can be extracted or unpacked from the interaction packet as described above. The decisive factor in all actions is that these actions are executed locally in an involved processing computer system so that safety-relevant passphrases or keys for processing and performing the actions have to be provided or used only locally on the respective computer systems and do not have to be exchanged within the computer network infrastructure, in particular between the primary broker computer system and the primary processing computer system. This fact also increases security against attacks from an external intruder.

The method of the type described above advantageously comprises the following steps:

generating an information packet by the primary broker computer system, wherein also task information of the task file and/or information about the at least one action to be performed by the group of processing computer systems is summarized in the information packet,

transmitting the information packet from the primary broker computer system to all from the group of processing computer systems,

responding, by at least one processing computer system within a predetermined or random time period, to the transmitted information packet with a readiness for the further processing, and

determining, by the broker computer system, the processing computer system that replies first to be the primary processing computer system.

For transmission of the information packet, each from the group of processing computer systems establishes a connection to the primary broker computer systems and fetches the information packet. In this regard, such a transmission is effected analogously to an above-described transmission of task information of the task file or a first interaction packet containing the task information.

In the course of the method, the above-mentioned measures of exchanging an information packet is preferably effected prior to the transmission described above of task information to the primary processing computer system (by the first interaction packet) and particularly initially serve to determine a primary processing computer system from the plurality of processing computer systems present in the computer network infrastructure. The second task information in the information packet may differ, overlap or be identical in content to/from the task information (in the first interaction packet) explained above.

To perform the measures, predetermined points in time or time periods (so-called “time-outs) are provided to reply to the processing computer systems or selection as to which computer system replies first, too late or not at all.

By the information packet, all processing computer systems receive a message concerning the task file and/or the actions to be performed by the task file. This way, each of the processing computer system may decide, whether it can, must, or is allowed to accept the respective task information or whether it can, must, or is allowed to accept the respective action by the task information.

By the measures explained above, an individual processing computer system performing the further processing or handling of the task information and/or performing of the involved action is advantageously identified.

Besides a distribution of loads on the side of the broker computer systems, an assignment or load distribution is effected on the side of the processing computer systems by the measures described here. This comes with the advantage that a dedicated computer system of a group of processing computer systems may assume a specific task. This may be effected in an automated manner by my method.

In particular, in a so-called manual task, e.g., upon approval of the task information by a processor of a group of a processors assigned to one or multiple processing computer systems, it may be required for continuous performance of the method to avoid the method to be dependent of a certain person. Thus, the explained measures allow a direct request to the group of processing computer systems by the information packet by the primary broker computer system and a subsequent selection and identification of a primary processing computer system which replies positive to the information package.

As an alternative or in addition to the determination of the processing computer system that replies first, other criteria may be considered for determination. It is possible to link a positive reply of a processing computer system with a feedback of predetermined processing information of the respective processing computer system. Such processing information may, for example, be availability, time, duration, load or the like, of the respective processing computer system.

It is possible to link individual or all processing computer systems to the primary broker computer system via further broker computer systems.

The step of negotiating a primary broker computer system advantageously comprises the following sub-steps:

waiting a predetermined or random first time period by a broker computer system after receiving the task file,

communicating a readiness to continue the processing as a primary broker computer system to all of the other broker computer systems by the broker computer system after lapse of the first time period,

renewed waiting for a predetermined or random second time period by the communicating broker computer system,

validating, after lapse of the second time period, by the communicating broker computer system that it is the only one with the readiness to continue the processing as a primary broker computer system, and

determining the communication broker computer system as primary broker computer system, if the validation was successful.

The above-mentioned measures, which may possibly be performed entirely or partially by any one from the group of broker computer systems, allow an automated (and, very probably, unambiguous) determination of a broker computer system to be the primary computer system (so-called “primary”) for the further distribution of an incoming task file.

Awaiting the first time period by each of the broker computer systems after receiving the task file may achieve that every broker computer system can decide if it can or shall forward information within the communication process in the function of a primary. After waiting the first time span, which can be predetermined individually for each broker computer system, one broker computer system communicates to the other broker computer systems that it will continue the processing as the primary. If another broker computer system receives this message, it will renounce to assume the role of the primary per se.

After a second time period, which can be longer than the first time period, for example, a broker computer system that declared itself as a potential primary to the other computer systems, re-assumes a contact to the other computer systems to validate that it is the only primary.

The sub-steps of negotiating a primary broker computer system are advantageously performed again (eventually with arbitrary waiting time at the beginning) if the validation by the communicating broker computer system as to whether this system is the only system with the readiness to continue the processing as the primary broker computer system was not successful.

Validation can be not successful, for example, if multiple broker computer systems indicate, possibly overlapping or at the same time, a readiness to continue processing as the primary system. Due to parallelism during negotiation, two or more broker computer systems could want to assume the role of the primary. However, according to my method, only a single primary broker computer systems may exist and can exist since load distribution, in particular a load distribution of task files between the involved broker computer systems is to be achieved.

Advantageously, the step of negotiating a primary broker computer system is performed again after each parallel reception of a task file by the group of broker computer systems. As an alternative, the negotiation of a primary may be stored. However, the primary broker computer system would preferably be verified again after each reception of a task file. If the verification results in a non-availability of the broker computer system, negotiation according to the sub-steps described above is again performed.

The step of negotiating a primary broker computer system is again performed after any change of the group of broker computer systems. A change may be an addition or a subtraction of broker computer systems in the cluster of the computer network infrastructure.

All of the involved computer systems of the computer network infrastructure, i.e., broker computer systems and processing computer systems are connected with one another in their communication via network paths. In the unfavorable event of failure of one or multiple network paths, a so-called “split-brain-problem” may occur in the computer network infrastructure. This problem occurs if network paths are interrupted such that two sub-systems develop which can no longer communicate with each other. In this case, one group is not aware of the other group and vice versa, since communication is split.

Upon occurrence of such a split-brain-problem, a plurality of primary computer systems may result upon negotiation and determination within the group of processing computer systems (which systems are eventually split in sub-systems). This way, redundant data packets would be established, transmitted and possibly processed by a plurality of primaries.

However, redundant data packets become apparent not later than upon arrival of identical packets at one target. Therefore, redundant data packets can be discarded so that a split-brain-problem leads to redundancy, however, but also to filtration of redundant information within the method. In the most unfavorable case, processing redundant packets within a processing computer system leads to diverging behavior. This can be accounted for by monitoring an identification of task packets so that measures can be taken for solving this problem.

In addition, redundant network paths can be used within the computer network infrastructure to minimize the probability of a split-brain problem.

My method advantageously comprises:

monitoring the primary broker computer system by the secondary broker computer systems for availability while performing the method, and

cancelling the method and re-negotiating a primary broker computer system if monitoring the primary broker computer system revealed that this system is not or no longer available.

In this way, it can be recognized that a primary broker computer system cannot or no longer assume the function of the primary. This leads then to a renewed negotiation of a primary according to the method steps explained above,

As an alternative or in addition to monitoring of the primary broker computer system, mutual monitoring of a plurality or of all the broker computer systems is possible. This provides the advantage that in a sudden non-availability of a plurality of broker computer systems, which is recognized by other broker computer systems, the indication of a split-brain-problem, as described above, could be the case. This could, for example, be communicated and logged by monitoring in view of possible redundancy of forwarded data packets or task files, respectively.

In my method the additional step is preferably performed:

transmitting an on-hold instruction from the primary broker computer system to all non-primary processing computer systems to indicate to them to enter a waiting mode. This way, the non-primary processing computer systems are told that (first) they shall not perform any further action with respect to corresponding task information.

My method additionally advantageously comprises the steps of:

transmitting a process-completed instruction from the primary broker computer system to all from the group of processing computer systems, after the at least one action was performed in the primary processing computer system,

cleansing and/or removing all data that has been generated for and during execution of the method in the processing computer system.

These measures come with a double advantage. A first advantage is that after performing the action in the primary processing computer system, all data stored on the involved processing computer systems involved in forwarding the task information (or as well other information or interaction packets, as described above) according to my method, can be cleaned. A second advantage lies with the fact that all processing computer systems (the primary as well as the non-primary) recognize that processing the task information or the action has been performed successfully.

A process-completed-instruction can alternatively also be sent after a re-transmission of the processed task information from the primary processing computer system to the primary broker computer system or to other predetermined points of time.

Transmitting the task information and/or other data packets and/or instructions from a broker computer system to a processing computer system preferably comprises the following steps:

sending a predetermined sequence of packet data from the broker computer system to the processing computer system, wherein the predetermined network ports of the processing computer systems are closed and wherein the sequence addresses one or more network ports of the processing computer system in a predetermined order,

verifying the sent sequence with a predetermined sequence in the processing computer system, and

causing the transmission of the task information and/or other data packets and/or instructions by the processing computer system, if the verification of the sent sequence is positive, wherein the processing computer system per se establishes a connection to the broker computer system and fetches the task information and/or other data packets and/or instructions.

The additional method steps indicated herein provide the advantage that basically the network ports (decisive to the method) of the involved processing computer system in the sense explained above) are closed and block a connection establishment from the exterior to the respective processing computer system or considerably complicate manipulative external access, respectively. Causing the transmission of the task information or other data packets and/or instructions by the receiving processing computer system can be an automated process to transmit the respective task information to the processing computer system (via the Unix-based command “Secure Copy,” scp, for example). According to the process, the processing computer system per se establishes a connection to the broker computer system and fetches the task file or other data packets. This process may be started after a predetermined sequence of packet data was sent to the processing computer system, if the sequence matches a predetermined sequence. The IP address of the sequence-sending computer system can be predetermined to be static in the processing computer system or can be taken dynamically from source IP-addresses of potential sequence-sending computer systems known to the kernel of the processing computer system.

Such a method is known under the term “port knocking.” The steps mentioned above can be performed by a so-called knock-daemon, i.e., a program that enables port knocking. This knock daemon listens to the network ports of the processing computer system, verifies the sent sequence of packet data and eventually causes (e.g., by starting a script/program) a controlled transmission of the respective task information from a broker computer system to the processing commuter system if the sent sequence matches a predetermined sequence. Therefore, the above-mentioned process allows transmitting/copying the task information from a broker computer system to the respective processing computer system without that the broker computer system has to provide an open port with a listening program to that end.

As an alternative or additionally to the above-described port knocking, it is also possible that the involved processing computer system per se requests at regular intervals at the broker computer system (polling) as to whether task information to be exchanged are present. If this is the case, a respective transmission of task information from the broker computer systems to the processing computer system can be initiated. It is also possible that the processing computer system performs polling when a certain time span, in which no port-knocking was performed, has lapsed, for example. Thus, port-knocking problems can be detected while maintaining functionality.

Communication between secured computer systems is thus possible within the computer network infrastructure via the group of broker computer systems. This way, the group of broker computer systems as well as the group of processing computer systems form some type of secure “communication middleware” wherein a load distribution is performed between involved computer systems.

I also provide a computer network infrastructure comprising at least:

a plurality of broker computer systems, and

a plurality of processing computer systems,

wherein the computer systems are configured to transmit data packets and/or instructions from at least one of the group of broker computer systems to at least one of the group of processing computer systems to process the data packets and/or instructions, wherein the group of broker computer systems and/or the group of processing computer systems are configured to negotiate and/or determine a primary broker computer system and/or a primary processing computer system, and wherein all from the group of processing computer systems each comprise one access control unit configured to close predetermined network ports so that access via a network by these network ports is prevented.

Advantageously, such a computer network infrastructure is configured to perform a method of the type explained above.

The advantages explained in conjunction with the method of the type described above result in an analogous way by a computer network infrastructure of this type. All advantageous measures explained in conjunction with the above method are used in corresponding structural features of the computer network infrastructure and vice versa.

I further provide a computer program product configured to be executed on one or multiple computer systems and which, when executed, performs a method of the type explained above.

Further advantageous examples are disclosed in the following description of the figures.

In the example shown herein, the computer network infrastructure comprises a group of broker computer systems, namely a task server 1 and a task server 2. The computer network infrastructure further comprises a group of processing computer systems, namely admin client 1, admin client 2, as well as admin client 3.

The processing computer systems admin clients 1 to 3 act as encapsulated systems with closed network ports. In the drawing, this is illustrated schematically by a hatched input/output level of these computer systems. That means that no running programs or services are required on the network ports of admin clients 1 to 3 for external addressability via network. Rather, access to admin clients 1 to 3 is not possible via network due to the respective closed network ports. Nevertheless, a respective user group can locally access admin client 1 or 2 or 3 to locally initiate actions there.

In contrast to the processing computer systems, the admin clients 1 to 3, the broker computer systems, i.e., task server 1 and 2, act as “open” systems. Thus, task servers 1 and 2 have at least one open network port, wherein a service or an application running on the task servers 1 and 2 allows external addressability or accessibility via network. In these computer systems, a network connection can be restricted via VPN (“Virtual Private Network”) or SSH (“Secure Shell”) so that only predetermined encrypted network connections with dedicated computer systems are permitted. Task servers 1 and 2 serve as brokers for communication and forwarding of data packets and/or instructions within the computer network infrastructure.

A predetermined process is configured for communication between the addressable broker computer systems, task servers 1 and 2 and the encapsulated processing computer systems, admin client 1 to 3 their respective network ports closed. Data packets and/or instructions can directly be transmitted from an admin client 1 to 3 to one or more task servers 1 and 2 and be stored there, because task servers 1 and 2 can directly be addressed via network.

In reverse direction, i.e., from task servers 1 or 2 in direction to admin clients 1 to 3, first a port-knocking process is performed, wherein a predetermined sequence of packet data is sent from one of the task servers 1 or 2 to one or a plurality of admin clients 1 to 3, wherein the network ports of the respective processing computer system are closed and wherein the sequence addresses one or more network ports of the respective processing computer systems in a predetermined order. Then, the sent sequence in the respective processing computer system is verified with a predetermined sequence as well as a transmission of a respective data packet and/or an instruction by the processing computer system is initiated if the verification of the sent sequence is positive.

In particular, the respective processing computer system starts a process that fetches a data packet to be transmitted from the respective broker computer system (task servers 1 or 2). Such a process can be effected via the Unix-based “secure copy” (SCP) instruction, for example. This way, despite encapsulated processing computer systems, the involved computer systems are capable of communicating with each other within the computer network infrastructure, forward data packets and/or give instructions.

In the following, a load distribution or selection of dedicated computer systems that process task files or task information of task files is to be explained by multiple method steps, indicated in the drawing as a numbering.

In a step 1, a task file is transmitted to task server 1 and task server 2 from a location not further defined herein, and stored there. The task file may contain instructions for a process (task) in one of the processing computer systems and/or on a target computer system not further specified here. Such a process may be, for example:

storing, supplementing and/or processing of transmitted data,

the restart of a program,

the instruction for physical access to the respective computer system,

recovery of backup data,

incorporating further data and/or information into a transmitted file or

SSH access to the respective computer system.

Corresponding combinations of such actions and instructions are, of course, possible.

After transmitting the task file to the respective task servers 1 and 2 in step 1, the servers perform a negotiation in step 2 as to which of the two task servers 1 or 2 performs the further processing of the task file as the primary broker computer system. To that end, both task servers 1 or 2 may wait predetermined time periods (time outs), after which task server 1 or task server 2 communicates, for example, that task server 1 will assume the further processing as the primary broker computer system (so-called primary). After the reception of a corresponding message to task sever 2, the latter will accordingly accept and confirm that task server 1 assumes the role of the primary.

If, due to a time overlap, both broker computer systems, task server 1 and task server 2, would like to assume the role of the primary, this is accounted for in a mutual validation and negotiation of a clear, exclusive primary.

In this way, a load distribution or selection of a computer system can be performed between the broker computer systems, task server 1 and task server 2, for the further processing of the received task file.

According to the example shown in the drawing, task server 1 assumes the role of the primary for the further processing of the received task file.

Task server 2 may either discard the task file or keep the task file for a fallback position in case of a failure of task server 2. Furthermore, task server 2 may also enter a waiting mode.

For the further processing of the task file, in particular, forwarding task information of the task file or the task file per se, within the computer network infrastructure, task server 1 generates an information packet, task information of the task file and/or information about at least one action to be performed by the group of processing computer systems summarized in the information packet. In particular, such information may be based on defaults within the task file, in particular provided or required signatures, provided time-outs, provided indications about the further processing of the task file or the like.

Also, information about the forwarding to all from the group of processing computer systems, i.e., both admin client 1 and admin client 2 and admin client 3, can be set according to a 1:n distribution or forwarding, respectively.

To that end, task server 1 requests predetermined routing information stored in the task file, wherein the routing information defines a predetermined communication-path-structure between task server 1 and the processing computer systems, admin clients 1 to 3.

In step 3, this routing information is processed for 1:n distribution to the processing computer systems.

In step 4, task server 1 performs (as described above) a port-knocking process toward all processing computer systems, admin clients 1 to 3. Admin clients 1 to 3 fetch the generated information packet from task server 1 then.

In step 5, which constitutes an essential method step, it is determined which of the processing computer systems admin clients 1 to 3 assumes the further processing of further task information by an evaluation of the transmitted information packet. Such a primary processing computer system may be determined by predetermined time-outs within the information packet and/or through the fact as to which processing computer system is the first that gives a positive reply to the transmitted and evaluated information packet. In the constellation illustrated in the drawing, admin client 2 defines that it wants to perform the further processing.

To that end, in step 6, admin client 2 computes a routing to task server 1 and transports a positive reply regarding the sent information packet to task server 1, in step 7.

In step 8, the positive reply is registered in task server 1 and admin client 2 is set to be the primary processing computer system. Thus, distribution of tasks or selection of a specific processing computer system for direct communication with the primary broker computer system, task server 1, is achieved on the side of the processing computer systems.

Furthermore, task server 1 generates an interaction packet in step 8, which in turn contains task information of the original task file. Besides this task information, the interaction packet may as well include further information (e.g., signatures, authorizations, instructions and the like) between task server 1 and admin client 2, wherein the information of the original task file is maintained. As an alternative, the original task file per se can be contained as the task information.

Furthermore, it is possible for the task information or the original task file per se to be secured by a signature of an independent key computer system (not further specified here). Such a “basic signature” remains verifiable despite packing the task information or the task file into the interaction packet and ensures the authenticity of the task information or of the task file. Such a “basic signature” provides a certain protection against falsification.

Parallel to this, in step 8, task server 1 generates so-called on-hold-instructions for admin client 1 and admin client 2 that form the non-primary processing computer systems. Such on-hold-instructions indicate to the admin client 1 and admin client 3 that they shall enter a waiting mode.

A routing to the respective processing computer systems admin clients 1 to 3 is computed in task server 1 in step 9. Fetching the interaction packet from task server 1 by admin client 2 after a respective port-knocking-process by task server 1 is effected in step 10. Fetching the on-hold instructions from task server 1 by admin clients 1 and 3 is effected in step 10 after analogously performing a port-knocking process by task server 1 toward these computer systems.

In step 11, which is also an essential step in the method, admin client 2 (as the primary computer system) extracts or unpacks the task information from the transmitted interaction packet and thereby determines an action to be effected locally on admin client 2. This action relates to the incorporation of further data in the task information and/or signing the task information locally within the admin client 2 with at least one private key and/or encrypting the task information with a public key of a target computer system, not specified in detail. According to the constellation of the drawing, signing task information may be effected by a private signature of a processor in admin client 2, for example.

In step 11a, the other processing computer systems, admin client 1 and admin client 3, process the fetched on-hold-instruction and switch to a waiting mode (“on hold”) for a request for further action on the side of task server 1.

In step 12, admin client 2 computes a routing of the processed task information back to task server 1, which has been communicated to it to be the primary broker computer system, by the previously-sent information packet, for example. Furthermore, admin client 2 can pack the processed task information in a second interaction packet after performing the respective action, the information packet containing feedback information for task server 1, for example.

In step 13, the second interaction packet generated in this way is transported back from admin client 2 to task server 1.

In step 14, task server 1 generates a process-completed instruction for all admin clients 1 to 3.

Furthermore, in step 14a, the supplemented and processed task information is updated in task server 1, for example, an information is added as to whether a predetermined step has been processed. Subsequently, in task server 1, the task file may be supplemented or re-generated by/from the task information that has been returned.

In step 15, task server 1 computes a routing of the process-completed-instruction to admin clients 1 to 3.

Furthermore, in step 15a, a routing is computed for a further transport of the updated task file by the processed task information toward a non-specified target computer system to perform a corresponding task in the target computer system.

In step 16, a port-knocking process is effected from the task server 1 toward all admin clients 1 to 3, wherein the latter fetch the processing-completed instruction from task server 1. By the process-completed instruction, all admin clients 1 to 3 receive an information as to whether that the procedure of processing the task information is completed.

Parallel to this, in step 16a, a further transport of the supplemented task file is effected in the direction of the target computer system not specified in more detail here so that the task file can finally be processed outside the constellation illustrated in the drawing.

In a final step 17, a data clearance, triggered by the process-completed instruction, is performed in each of admin clients 1 to 3 regarding the data accrued in connection with the performed method, and potentially executed jobs and actions are removed. Step 17 can be coupled to a timing. This means that step 17 is performed automatically if a predetermined duration has been surpassed, regardless of which step has been performed at the moment. Furthermore, a user of each admin client 1 to 3 can be informed about the end of the respective action during performance of step 17.

The method ends here.

In addition, a further step 18 (not illustrated) can be provided, in which the information that the action has successfully been completed, is passed from task server 1 to task server 2. If this is not effected within a certain time period, task server 2 may try to negotiate the role of the primary (on its own behalf now) again and possibly repeats communication with admin clients 1 to 3 according to the method explained herein. A notification from task server 1 to task server 2 may optionally be effected as to when the predetermined time span for the action was surpassed, the action not (successfully) being completed by the admin clients however. Thereby, task server 2 receives the information that the action is “formally” completed. Step 18 may be implemented in the method as the final step after step 17 or alternatively prior to step 17.

Advantageously, every data packet exchanged between the involved computer systems is provided with an identifier in at least one involved computer system. As an alternative, an already existing identifier of a respective data package can be supplemented. This provides the advantage that a data package can be traced even across a plurality of entities of the communication path structure. Supplementing an identifier may consist in providing it with an unambiguous supplement, for example.

The route of the data packets along the communication path structure can be monitored by a monitoring based on the identification, possibly in conjunction with provided signatures (falsification-proof). Also, a residence time of the data packets on an involved computer system along the communication path structure can be monitored. Furthermore, all method steps can be logged by the monitoring.

By the identifier of a data packet, possibly in conjunction with stored routing information and/or signatures, it can be determined whether the communication path structure is respected and which computer systems can and may be successfully reached. It can be verified by the identifier whether task information has successfully been transmitted from the primary broker computer system, task server 1, to the primary processing computer system, admin client 2, according to the illustrated constellation.

A residence time can be defined within the task file, for example. It can be set that task information of the task file may not or cannot be transported further or possibly becomes unfeasible after lapse of the residence time. This increases data security and conflict management within the computer network infrastructure, respectively.

If required, alerts can be generated or other measures can be taken by the monitoring.

The monitoring (not illustrated in detail in the example) can either be realized by the involved computer systems per se or executed by further computer systems not further specified herein. Furthermore, it is possible and advantageous to perform the monitoring by a separate network path structure.

The constellation from a computer network infrastructure illustrated herein is merely chosen by way of example. For reasons of clarity, merely essentially-involved components are illustrated.

1-15. (canceled)

16. A method of distributing tasks between secured computer systems in a computer network infrastructure, comprising:
parallel receiving a task file by a plurality of broker computer systems;
negotiating a primary broker computer system from a group of broker computer systems for further processing of the task file;
transmitting task information of the task file from the primary broker computer system to a primary processing computer system from a plurality of processing computer systems; and
performing at least one action in the primary processing computer system by the transmitted task information,
wherein all from the group of the processing computer systems keep predetermined network ports used for the method closed such that no connection establishment from the exterior is permitted and thus access via a network by the network ports is prevented, and
a respective processing computer system is capable of establishing a connection to a respective broker computer system to fetch respective task information of the task file from the broker computer system.

17. The method according to claim 16, further comprising:
generating a first interaction packet containing the task information by the primary broker computer system;
transmitting the first interaction packet from the primary broker computer system to the primary processing computer system;
extracting the task information from the first interaction packet to perform the at least one action in the primary processing computer system;
generating a second interaction packet containing a reply to the first interaction packet, by the primary processing computer system; and
transmitting the second interaction packet from the primary processing computer system back to the primary broker computer system after performing the at least one action.

18. The method according to claim 16, wherein the at least one action comprises at least:
supplementing the task information by further data, and/or
signing the task information with at least one private key, and/or
encrypting the task information with a public key of a target computer system.

19. The method according to claim 16, further comprising:
generating an information packet by the primary broker computer system, wherein task information of the task file and/or information about the at least one action to be performed by means of the group of processing computer systems is also included in the information packet;
transmitting the information packet from the primary broker computer system to all from the group of processing computer systems;
responding, by at least one processing computer system within a predetermined or random time period, to the transmitted information packet with a readiness for the further processing; and
determining, by the broker computer system, the processing computer system that replies first to be the primary processing computer system.

20. The method according to claim 16, wherein negotiating a primary broker computer system comprises:
waiting a predetermined or random first time period by a broker computer system after receiving the task file;
communicating, by the broker computer system, a readiness to continue the processing as the primary broker computer system to all of the other broker computer systems after lapse of the first time period;
waiting for a predetermined or random second time period by the communicating broker computer system;
validating, after lapse of the second time period, by the communicating broker computer system, that the system is the only one with the readiness to continue the processing as the primary broker computer system; and
determining the communicating broker computer system to be the primary broker computer system, if the validation was successful.

21. The method according to claim 20, wherein negotiating a primary broker computer system are performed again if the validation by the communicating broker computer system as to whether this system is the only one with the readiness to continue the processing as the primary broker computer system was not successful.

22. The method according to claim 16, wherein negotiating a primary broker computer system is performed again after every parallel reception of a task file by the group of the broker computer systems.

23. The method according to claim 16, wherein negotiating a primary broker computer system is performed again after every change of the group of broker computer systems.

24. The method according to claim 16, further comprising:
monitoring the primary broker computer system by the secondary broker computer systems for availability while performing the method; and
cancelling the method and re-negotiating a primary broker computer system if monitoring of the primary broker computer system revealed that this system is not or no longer available.

25. The method according to claim 16, further comprising:
transmitting an on-hold-instruction from the primary broker computer system to all non-primary processing computer systems to indicate that these systems shall enter a waiting mode.

26. The method according to claim 16, further comprising:
transmitting a process-completed instruction from the primary broker computer system to all from the group of processing computer systems after the at least one action was performed in the primary processing computer system; and
cleansing and/or removing all data that has been generated for and during execution of the method in the processing computer systems.

27. The method according to claim 16, wherein transmitting the task information and/or other data packets and/or instructions from a broker computer systems to a processing computer system comprises:
sending a predetermined sequence of packet data from the broker computer system to the processing computer system, wherein the predetermined network ports of the processing computer system are closed, and the sequence addresses one or more predetermined network ports of the processing computer system in a predetermined order;
verifying the sent sequence with a predetermined sequence in the processing computer system; and
causing the transmission of the task information and/or other data packets and/or instructions by the processing computer system if verification of the sent sequence is positive, wherein the processing computer system per se establishes a connection to the broker computer system and fetches the task information and/or other data packets and/or instructions.

28. A computer network infrastructure comprising:
a plurality of broker computer systems; and
a plurality of processing computer systems,
wherein the computer systems are configured to transmit data packets and/or instructions from at least one of the group of broker computer systems to at least one of the group of processing computer systems for processing the data packets and/or instructions,
the group of broker computer systems and/or the group of processing computer systems are configured to negotiate and/or determine a primary broker computer system and/or a primary processing computer system for communication,
all from the group of processing computer systems each comprise one access control unit configured to close predetermined network ports used for the method such that a connection establishment from the exterior to the processing computer systems is not permitted and thus access via a network by the network ports is prevented, and
the processing computer systems are configured to establish a connection to a respective broker computer system to fetch corresponding data packets and/or instructions from the respective broker computer system.

29. The computer network infrastructure according to claim 28, configured to perform a method comprising:
parallel receiving a task file by a plurality of broker computer systems;
negotiating a primary broker computer system from a group of broker computer systems for further processing of the task file;
transmitting task information of the task file from the primary broker computer system to a primary processing computer system from a plurality of processing computer systems; and
performing at least one action in the primary processing computer system by the transmitted task information,
wherein all from the group of the processing computer systems keep predetermined network ports used for the method closed such that no connection establishment from the exterior is permitted and thus access via a network by the network ports is prevented, and
a respective processing computer system is capable of establishing a connection to a respective broker computer system to fetch respective task information of the task file from the broker computer system.

30. A computer program product configured to be executed on one or a plurality of computer systems and which, when executed, performs the method according to claim 16.
